(19) United States
(12) Patent Application Publication
(10) Pub. No.: US 2011/0252351 A1
(43) Pub. Date: Oct. 13, 2011

(54) SYSTEMS AND METHODS FOR CONSUMING, SHARING, AND SYNCHRONIZING TIME BASED INFORMATION

(75) Inventors: Scott Sikora, Seattle, WA (US); Derek Robbecke, Renton, WA (US); Celeste Marie Combs, Burien, WA (US)

(73) Assignee: CALAMANDER INC., Seattle, WA (US)

(21) Appl. No.: 13/084,346

(22) Filed: Apr. 11, 2011

Related U.S. Application Data
(60) Provisional application No. 61/322,563, filed on Apr. 9, 2010.

(51) Int. Cl. G06F 3/048

(52) U.S. Cl. 715/769; 715/764; 715/843

(57) ABSTRACT

Methods, techniques, and systems for a calendar management system are provided. Some embodiments provide a calendar management system that is configured to receive calendar identification information from a user; access at least one disparate calendaring system, wherein the at least one disparate calendaring system is related to the received calendar identification information; and integrate calendar data from the accessed at least one disparate calendaring system in a calendar environment user interface.

### RELATED APPLICATIONS

This applications claims priority to and the benefit of U.S. Provisional Application Ser. No. 61/322,563 filed on Apr. 9, 2010, which is hereby incorporated by reference as if set forth in their entirety herein.

### TECHNICAL FIELD

The present disclosure relates to methods, techniques, and systems for facilitating a calendaring management environment and, in particular, to methods, techniques, and systems for accessing calendar data from one or more disparate calendaring systems and presenting synchronized integrated calendar data to a user.

### BACKGROUND

Everything that occurs in the world, every meeting, every event, every choice, involves a decision about time. If you are looking for a new home, the open houses are on certain dates and times. If you are running a family, you must actively manage school and sport schedules. If you want to waste time, there are countless entertainment options to consider. While technology has revolutionized almost every area of our lives, technological advancement has paradoxically made it impossible to efficiently consider time in our everyday choices. Time requests come via email, phone calls, meeting requests and it is increasingly difficult to keep track of each event, especially tracking both business and personal calendars.

### BRIEF DESCRIPTION OF THE DRAWINGS

Preferred and alternative examples of the present invention are described in detail below with reference to the following drawings:

FIG. 1 is an example block diagram of example components of an example calendar management environment;

FIGS. 2A-E are example screen displays illustrating an example calendar management system;

FIG. 3 is an example block diagram of an example computing device for practicing embodiments of a calendar management environment;

FIG. 4 is an example flow diagram of an example calendar management environment;

FIG. 5 is an example flow diagram of example synchronization provided by an example embodiment of calendar management environment; and

FIG. 6 is an example flow diagram of example synchronization provided by an example embodiment of calendar management environment.

### DETAILED DESCRIPTION OF THE PREFERRED EMBODIMENT

In the following description, certain specific details are set forth in order to provide a thorough understanding of various embodiments of the invention. However, one skilled in the art will understand that the invention may be practiced without these details or with various combinations of these details. In other instances, well-known systems and methods associated with, but not necessarily limited to, digital calendars and methods for operating the same may not be shown or described in detail to avoid unnecessarily obscuring descriptions of the embodiments of the invention.

There are numerous pure calendaring solutions available to a user. While many of these solutions offer the ability to create multiple calendars and to share calendars with others, none provide calendar interoperability—the capability to manage calendars and events across the large range of disparate calendar systems and maintain relationships between multiple calendars and events. For example, a user may need to maintain separate work and personal calendars without merging the two of them. Further those calendars may exist on different providers. Similarly, with traditional calendaring technologies it is difficult to share and update events with family, friends, and colleagues. While most systems allow for a mechanism to invite and track attendees to scheduled events, this mechanism is often too cumbersome when managing day to day activities. It is also often limited based upon the calendar solution employed by the meeting organizer, which may not be the same as that used by the attendees. It is also typically very tedious and manually intensive to enter event information into various calendaring solutions. Further, daily users are presented with time based and event information throughout the day in various forms (email, web pages, text messages, etc.). The user must then manually convert that information into something that can be processed by a conventional calendar.

An embodiment of the invention may be deployed on or used in conjunction with, but is not limited to an internet based service, accessible via a browser, a phone service, a text message based service, an application on a mobile device, as a private label solution, a computer application, and/or as functionality embedding into existing or future calendar based systems. In an embodiment there are a plurality of components for time based event sharing and synchronization. These components may include but are not limited to desktop browser and mobile device applications, calendar and event management API; remote calendar synchronization, text event parsing, drop boxes and the creation and maintenance of calendar and event relationships.

Example calendar management systems may include a client device (e.g., computer, portable computer, mobile computing device, and/or any device capable of wired or wireless connection to network), from which it accesses calendar data (e.g., events, appointments, reminders and/or any other indication of a time based event) from disparate calendaring systems (e.g., Google® calendars, Microsoft Outlook®, and/or the like). The example calendar management system communicates with disparate calendaring systems to obtain calendar data. Upon receipt of the obtained calendar data, in an example embodiment, the calendar management system integrates and presents calendar data from multiple disparate calendaring systems in one user interface.

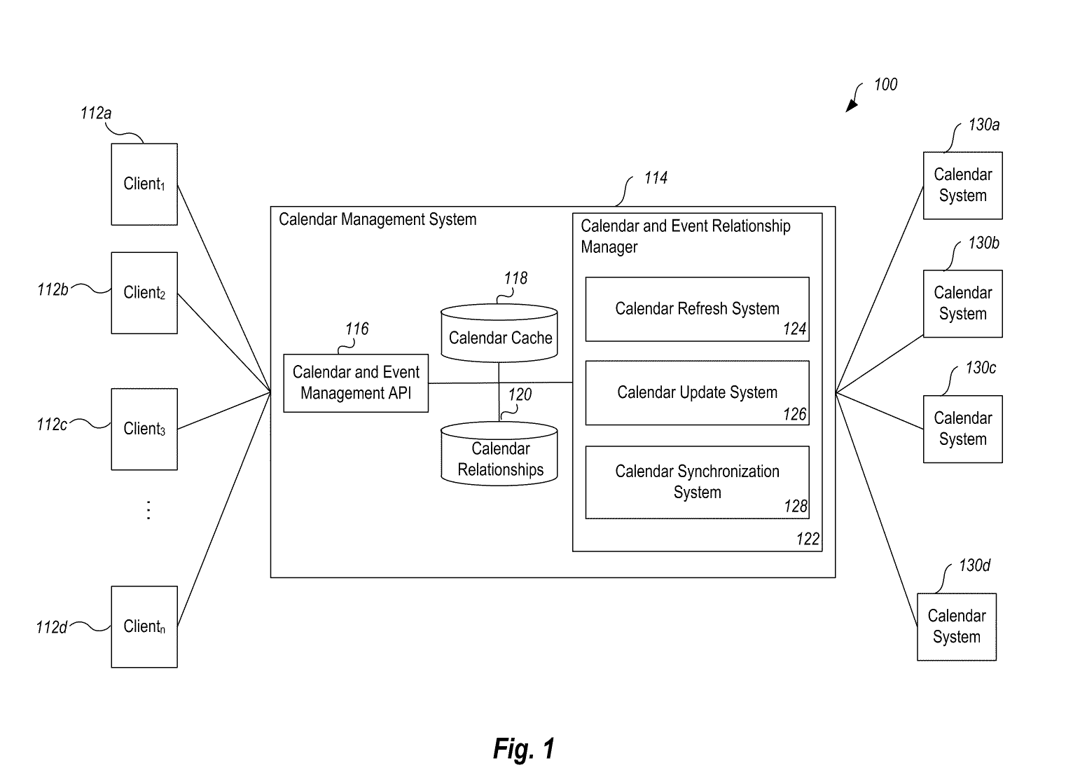

FIG. 1 is an example block diagram of example components of an example calendar management environment. FIG. 1 depicts an example calendar management environment 100 that includes a plurality of client devices 112a-d, a calendar management system 114 (a code module/component), and at least one calendar system 130a-d (e.g. disparate calendaring systems). The components of the illustrated calendar management environment 100 provides various logic (e.g. code, instructions, functions, routines, etc) and/or services related to the near real time gathering of calendar data from disparate calendaring systems. The calendar management system 114 controls the gathering of calendar data. In particular, the calendar management system 114 provides functions relating to the overall management of the calendar management environment 100, such as calendar data requests from client devices 112a-d. In addition the calendar management system 114 may provide other capabilities, such as calendars as an enterprise communication channel for delivering time based information to consumers; sharing of calendars regardless of source or provider; synchronization relationships, child (1 way) or peer (2 way) synchronization between disparate calendars; filtering events to only synchronize those of a particular interest rather than all events; maintaining a relationship between calendar events on disparate calendars and/or other administrative tasks related to the implementation of the calendar management system 114.

The calendar management system 114 comprises a calendar and event management API 116, calendar cache 118, calendar relationships data store 120 and a calendar and event relationship manager 122.

The calendar and event management API 116 preferably includes a set of API's to support the user interface as described above. These API's may support specifying calendar services and calendars, event creation and updates, calendar and event retrieval, creating and establishing relationships between events and calendars and/or sharing calendars and events with friends. The API 116 may also provide the ability to obtain aggregate, statistical and individual reporting data, including, but not limited to the type, number, time, date location and textual information about calendars, events, relationships and people. The API 116 may also be offered as a service to partners who wish to provide a wider reach of calendar access or leverage the synchronization or sharing capabilities as part of their offering.

The calendar cache 118 preferably stores calendar data retrieved from client devices 112a-d and/or calendar systems 130a-d. The calendar relationships data store 120 preferably stores relationships between events in calendar systems 130a-d and/or relationships between calendar systems 130a-d. An embodiment of the invention may not require its users to have established calendar repositories on remote systems when accessing a new calendar. Rather it may allow the creation and maintenance of calendars within its own data store. This store could also support the import of calendars from other programs such as, but not limited to, ICS files.

The calendar and event relationship manager 122 includes a calendar refresh system 124, a calendar update system 126 and a calendar synchronization system 128. The calendar refresh system 124 allows for the monitoring of calendar sources 130a-d for changes, so that relationships can be followed or the cache updated. Changes, additions and deletions can be monitored across the calendar sources 130a-d accessed by the calendar refresh system 124, and optionally share these changes with other calendar sources 130a-d. The calendar update system 126 provides a user operating a client device 112a-d the ability to update calendaring systems 130a-d by providing an update in the user interface.

The calendar synchronization system 128 allows for synchronization between calendars either within the same calendar service or more likely across disparate services in which case all events and updates in one calendar are transferred to another. The synchronization relationship may be 1 way (“is child of”) or 2 ways (“is peer of”). Filtering may also be applied to the synchronization relationship such that only a preferred subset of events is transferred between calendars. Origination of events that are created or updated as a result of a synchronization relationship is preserved to support maintaining proper state of events as well as removing events from a calendar if a synchronization relationship is removed.

The calendar and event relationship manager 122 includes processes to update remote calendars, even from different providers, with information supplied from a user interface or alternatively established interfaces. A consistent “create”, “read”, “update” and “delete” event functionality for each calendar is provided, even if the calendars exist on separate providers. Remote synchronization can synchronize user calendars and/or individual events. Calendars and events can be retrieved and maintained locally in the calendar cache 118 for performance considerations. Calendars are preferably cached and maintained in an industry-standard iCalendar format which is intended to be calendar service agnostic. The synchronization processes can continue on the basis of one or more various protocol implementations (i.e. activesync, caldav, syncml etc.) for interfacing with the remote calendar services. Advantageously or additionally, some embodiments integrate and synchronize event information with proprietary calendaring systems such as those on Facebook®. An embodiment allows for access to remote calendar providers that may provide only read only calendars, such as those contained in an HTML format, or published in an iCalendar ICS format.

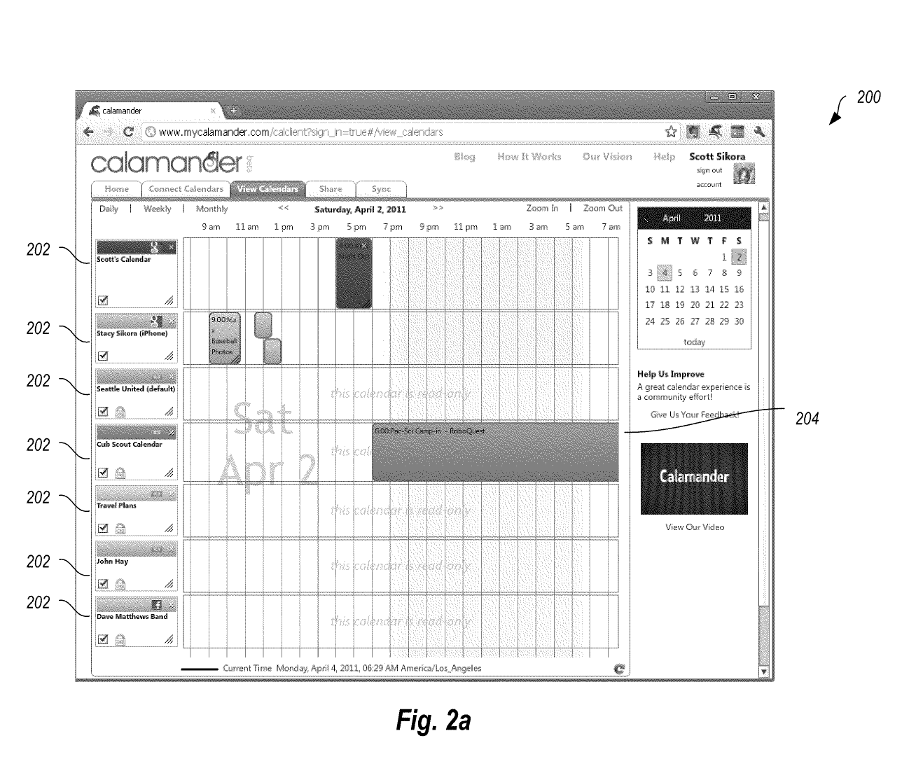

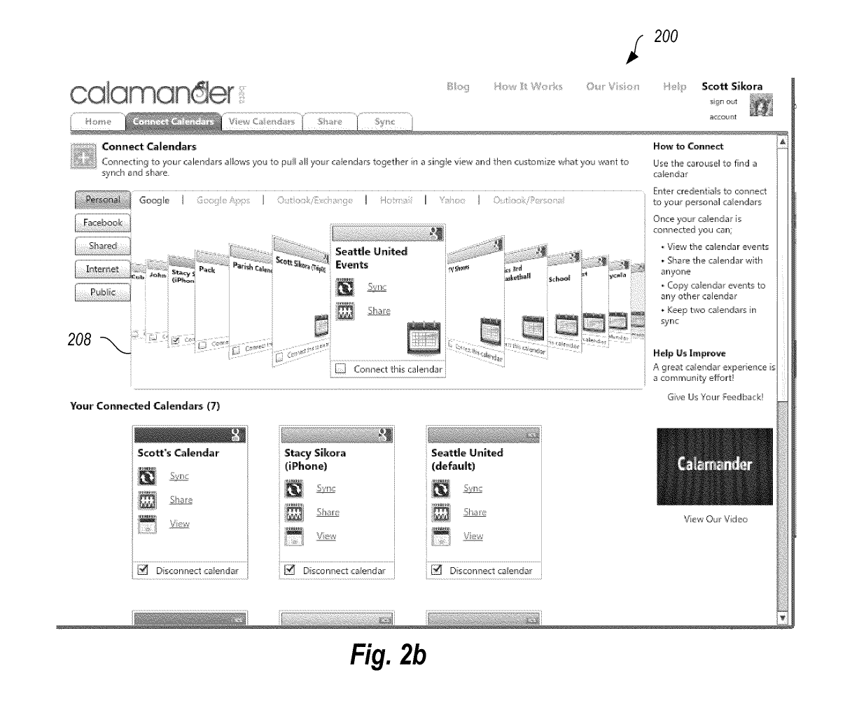

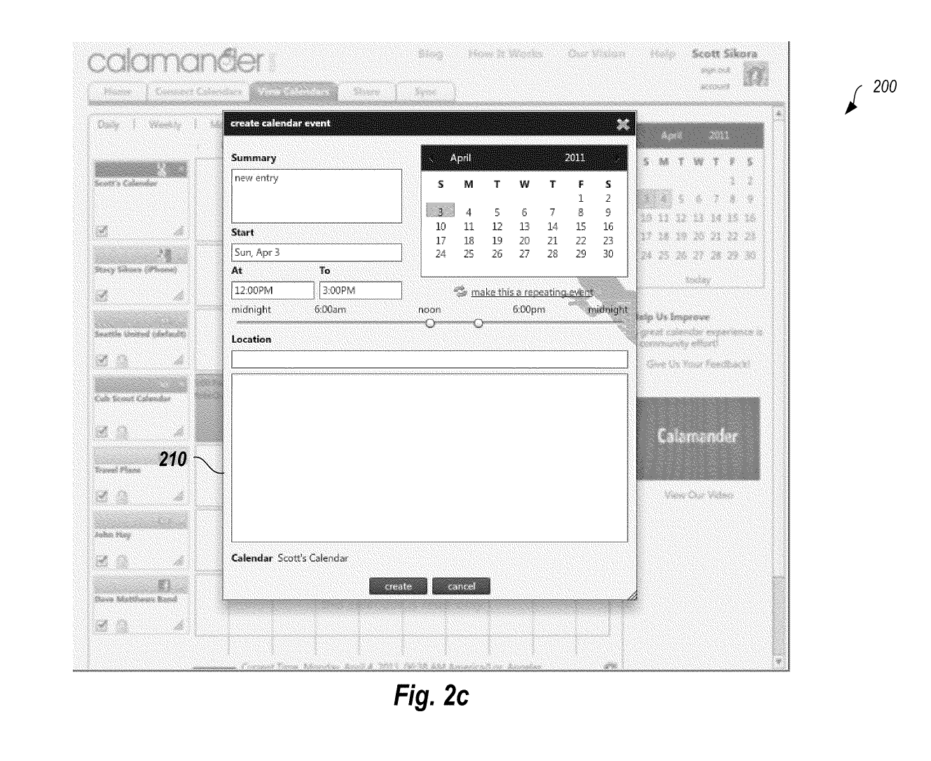

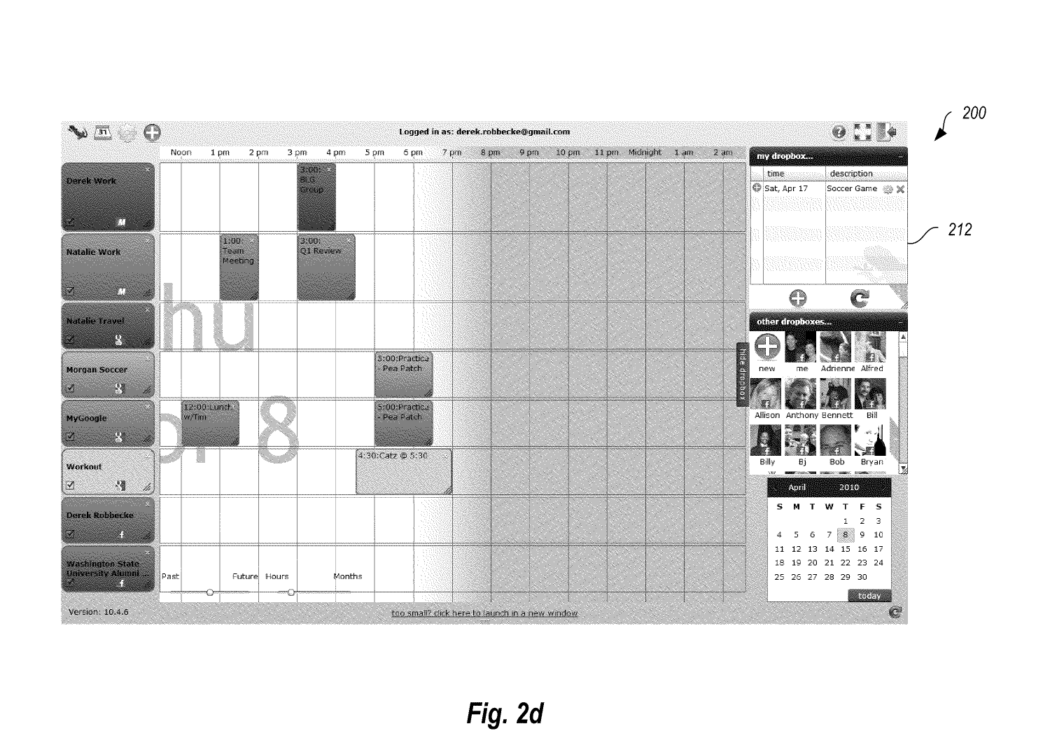

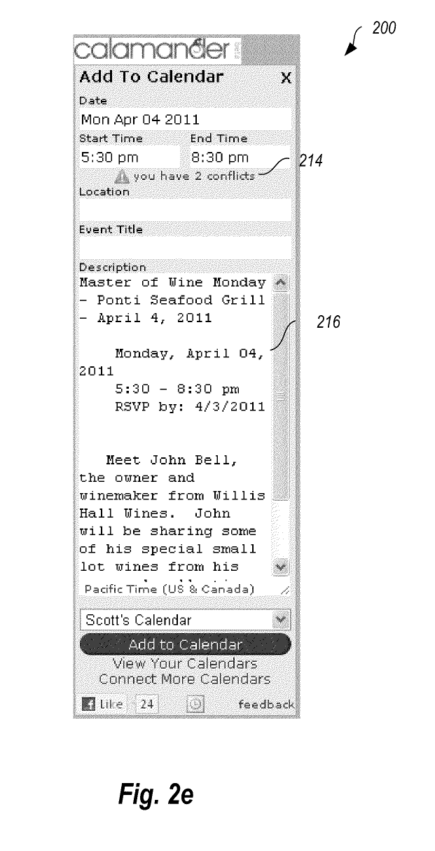

The desktop browser and mobile device applications operated by client devices 112a-d may include a user interface (FIG. 2a) for managing time based information and relationships across multiple calendars and linking event information with other users such as family, friends and colleagues. Disparate calendars, events, relationships between calendars and events and people can be displayed and managed in preferably a single comprehensive user interface. This interface allows for the management of calendar events and creating relationships between events and calendars via intuitive drag-and-drop mouse or touch screen gestures. Management is preferably further enhanced through the provisioning of an unlimited “undo” facility when working with calendars and events. The user-interface and the calendar and event management API 116 may also allow: (1) the grouping of calendars so they can be displayed as one calendar, even though they may be comprised of several distinct calendars; and (2) the ability to limit calendar viewing to that of just free/busy time periods versus providing event detail that is intended to be concealed.

In some embodiments, the interface will be integrated into a web site, where linking and sharing of calendar and event information can occur entirely within the user interface look-and-feel of the hosted web-site. In some embodiments, the user interface may exist as a program and/or service accessed via a mobile handset, such as an iPhone, Blackberry or other mobile device. Certain mobile device embodiments may include the capability to quickly pass calendar and event data from one user to another through proximity of the devices instead of a user interface.

In an example embodiment, the calendar management system 114 allows for time based information, including events and groups of events. The information may be dropped in a “drop-box” that acts as a repository for all time based information that can act as a temporary storage area or triage for event information before being moved onto a new or existing calendar, or alternatively shared with friends. The drop-box is preferably a mechanism by which the user can place submitted events into one or more calendars. The drop-box contents are preferably fully formed events or links to entire calendars. Events are submitted either from raw text information that gets processed and parsed or from events that are shared from fellow users of the system.

An embodiment includes calendar interoperability, relations and visualization either alone or in combination. Relationships can be created and maintained between events and calendars, so that an updated event will propagate to all other events that have an active relationship. Calendars and events may also be shared across disparate systems or with people who are not users of the original calendaring product. The sharing relationship allows for the notification of updates and the ability to perform analysis on sharing tends and metrics for business and product related calendars. Notifications may include but are not limited to email, voice and SMS messages and may be provided when there are changes to an event, calendar or to the relationship between the event or calendar and the subscribing party. Information is efficiently managed by developing relationships between time information. Time based information, by nature, is continually changing as the present becomes the past, and “in two weeks” becomes “next week.” In preferred embodiments, the relationships between events allow for time based decisions. Relationships are stored in the calendar relationships data store 120.

In an embodiment, an infrastructure and user interface provides the ability to share events and calendars with other users through social networking sites. The user-interface supports the organization of other users into groups, so that they can easily be identified or calendars or events can be shared with groups. In some embodiments, there exists the potential to allow users to share any calendar across any provider. This may be accomplished by a web-based synchronization service, managing the relationships between users, their calendars and their providers. In some embodiments the web-based synchronization service includes social networking API's to allow for one click calendar sharing and publishing. The infrastructure may also allow those participating in the shared calendar or event to provide additional comments or information pertaining to it.

An embodiment further includes the ability for companies and organizations to create, publish and/or maintain calendars for user subscription and consumption. These calendars may contain business related events that provide a channel for marketing and promotional information that can be made available for consumers. Additionally this embodiment could allow an organization to publish a calendar with related activities that can be subscribed to by consumers, perhaps for a fee.

The calendar management system 114 provides the ability to publish public calendars that may be of interest and can be categorized based upon location and subject.

An embodiment includes the ability to search for calendars. Search infrastructure is provided to easily search for, or be made aware of, calendars of interest and provide the means to subscribe to those calendars and receive notifications of updates.

Often an event has logistical implications that may impact a calendar beyond the bounds of its particular start and end times. An example might be travel time required between adjacent activities. An embodiment of the system may provide capabilities for assessing and planning for these types of constraints and provide the mechanisms to properly account for them.

An embodiment further includes functionality to parse and process text based event information from sources such as web pages, email, voice (after being processed via text-to-speech), and SMS messages to easily transform them into actionable calendar events with a toolset. For example, the system and method may include the ability to parse an incoming email to extract relevant calendar data to be imported into a relevant calendar. Text event parsing may include parsing raw text information into time based, actionable events. Natural language parsing may be leveraged for extracting event information from various sources such as email, web pages and SMS messages. Parsing may further include “smart tag”ing that may be a web browser program module plugin that allows for a user to capture text information from a web page. Some web browser based embodiments may be in the form of a single button “add this” for processing text information into time based events. Text based event information may be parsed and processed from sources such as web pages, email, voice, and SMS messages to easily transform them into actions or calendar events within a toolset. There are many sources where time-based information is carried but not managed (such as web pages, emails, and SMS). Further embodiments include the use of natural language algorithms to contextually parse emails, text messages, canned pages, documents etc. For example, if a child's baseball schedule is in paper form and scanned, the document can be parsed and input. A further example includes finding a website having an event and automatically entering the event in a calendar, using a program module (or plug-in) available on the user's browser. Alternatively, a meeting schedule may exist in a spreadsheet, which can be automatically parsed into a group of events.

Information about calendars, events and relationships may be made available through the infrastructure, optionally using a combination of the user interface, and back-end API calls. This information may be available to be searched upon by consumers, or may be used to create corporate communications to be placed inside the UI, the calendar or the events. An embodiment of the system may record and track the relationships and sharing of published calendars for the purposes of reporting on the effectiveness of such publications and promotions.

Note that although FIG. 1 depicts data flows, such data flows may occur with varying levels of indirection in other embodiments. For example a request from client device 112a-d may be forwarded directly to the calendar sources 130a-d.

FIGS. 2A-E are example screen displays illustrating an example calendar management system for consuming, sharing, and synchronizing time based information according to an embodiment of the invention.

An embodiment of the invention provides a toolset for managing and maintaining multiple, disparate calendars in a single user interface 200. As shown in FIG. 2A, the disparate calendars 202 are displayed in a unique timeline format making it easy to see and edit the contents 204 of each—rather than just the traditional view where events are merged into a day/week/month view. This interface 200 preferably focuses on displaying not just the events themselves, but also the relationships between events. The interface 200 also may allow calendars to be displayed in priority order, where calendars of primary interest can be distinguished from calendars that are of secondary or even passing importance.

To populate the calendar “timeline view” in FIG. 2A, a user is preferably able to define remote services where their calendars reside. As shown in FIG. 2B, for each service, the user can select individual calendars 208 that they wish to be displayed in the timeline view (FIG. 2A). Each remote service definition includes the type of the remote calendar provider (such as Google®, Outlook® or other) and user login credentials. The system may allow connections to calendars hosted by popular providers, such as Google®, Google® Apps, Outlook/Exchange®, Hotmail® and Yahoo®. The system also may allow connections to calendars hosted on the internet in ICS; allow access to calendars shared by others, calendars hosted on social network sites, such as Facebook; and/allow access to a library of public calendars, categorized by location, such as Seattle, Wash., and by category, such as Concerts or Family.

FIG. 2c illustrates the creation of a new event on a calendar. In an example embodiment, when the calendar and time for the new event is clicked a rubber band box is created specifying the new event. A “new event” dialog 210 is then presented with the correct time and date of the new event, ready for user entry and the option to either cancel or confirm the operation. It is here that the proper information such as summary, end time, location and description can be supplied for the event. Once complete the event may be synced with the remote service associated with the calendar.

To link events across calendars, a desired event may be selected by double clicking it and dragging it onto the additional calendar. Other selection means may also be used. Once dropped onto the additional calendar, the system may sync with the remote service and create the event on the remote calendar.

FIG. 2d provides a dropbox 212 whose purpose is to provide an easy to use “holding” area for well-formed, actionable event information that may then be placed onto the proper calendar or dismissed altogether. Events and calendars can be placed in the dropbox 212 through a variety of channels, including, but not limited to the user interface, web pages and emails. When pending events are present in the dropbox 212 they may be placed onto any calendar in the timeline view. In an example embodiment, to add a dropbox 212 item to a calendar the event must be selected. Once an item is selected the timeline view is immediately placed into the context of that events timeframe. This facilitates identifying any possible conflicts and properly handling the event. Once a calendar is selected for the event then a user may drop the event into the lane of the timeline. Once dropped onto the destination calendar, the system will preferably sync with the remote service and create the event on the remote calendar.

In an exemplary embodiment, the system provides many ways to place items into user's calendars to accommodate the multiple channels in which we are inundated with time based information. In an example embodiment, the system provides a “smart tagging” mechanism that can be invoked from within any webpage. Once the SmartTag system is activated all the text areas within the web page are made to be selectable. The text is preferably highlighted when hovered over with the cursor. The text is selected by holding down the mouse button. The selected text can then be drug into the SmartTag dialog 216 of FIG. 2E and dropped into the appropriate fields. Time related information may be automatically parsed and placed in the time fields. When the selected text is released it is then parsed and the appropriate SmartTag dialog fields are populated. The SmartTag dialog 216 further includes the ability to check for conflicts with current calendars. As is shown by warning 214, the system is configured to check for time conflicts anytime an event is created. When the event is fully defined it can then be placed into the user's dropbox using the button provided in the SmartTag dialog 216. The smarttag system also allows for the user to navigate directly to the user interface for placing the item onto a calendar.

In an example embodiment, calendar entries can also be created directly from emails. If an email message contains time related information that should be placed onto a calendar it can be forwarded to the dropbox. The system preferably monitors this mailbox for messages and will parse their contents for event information. If an event can be formed it will be placed in the proper dropbox based upon the forwarding email address.

It is often the case where one might like to share an event with someone whose calendar they do not have direct access to. Also, it sometimes preferable to share event information in a manner where the recipient can manage it rather than placing directly onto their calendar. In an example embodiment, the system provides the means to share events with friends and colleagues by making events accessible to them within their own dropboxes.

In an exemplary user interface there is a window of “other dropboxes”. These are all people with whom an event can be shared. These can be from friend's social networking sites such as Facebook® or people who were manually entered by supplying their name and email address. If the other dropbox was manually defined by providing a name and email address then an email will be sent to the recipient notifying them of the event. The email may also contain an attachment with the event represented in industry standard ICS format that can be imported into most calendar systems. Additionally, if it is determined that the recipient is a user, based upon their email address, then a copy of the event is also placed directly into their dropbox 212 so that they can leverage the full toolset.

In an exemplary embodiment, the system may be linked to social networking sites such as Facebook®. If this linkage exists for a user then all of their friends are made available as “other dropboxes”. If an event is shared with one of these dropboxes then a posting is made to their wall to notify them of the event and provides options to act upon the event.

In certain circumstances it may be desirable to share an entire calendar. This might be to share personal calendars with family members or trusted colleagues, or to give access to calendars of a public nature such as the schedule for a youth sports league team.

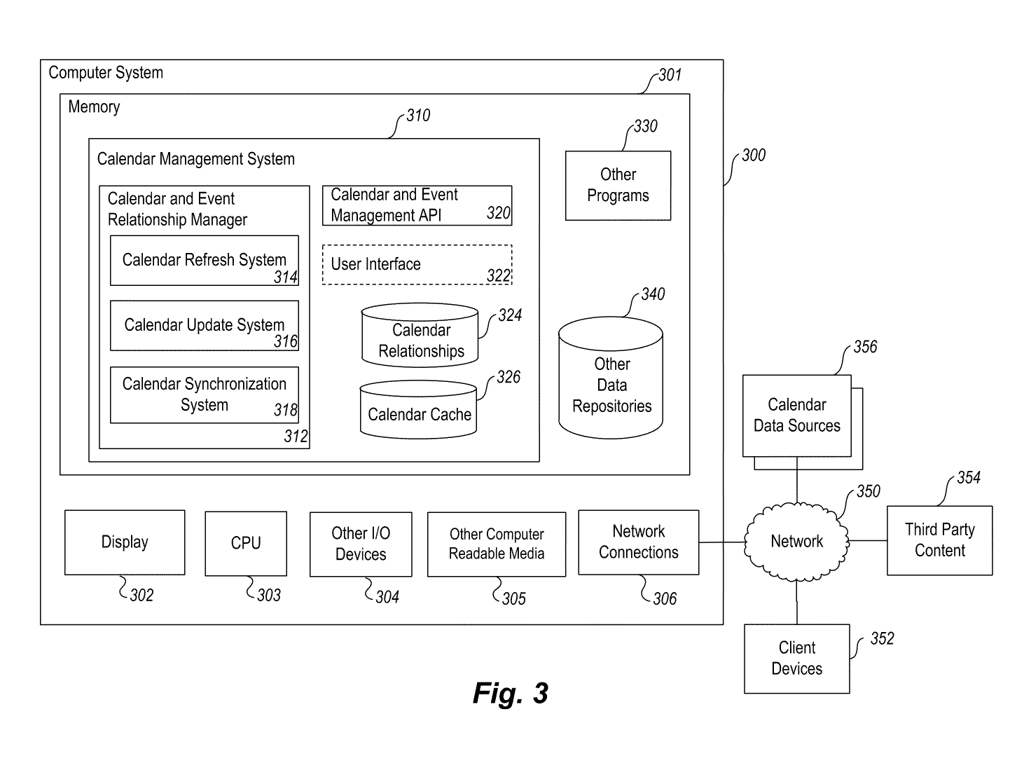

FIG. 3 is an example block diagram of an example computing device for practicing embodiments of a calendar management environment. In particular, FIG. 3 shows a computing system 300 that may be utilized to implement a calendar management system 310. Note that one or more general purpose or special purpose computing systems/devices may be used to implement the calendar management system 310. In addition, the computing system 300 may comprise one or more distinct computing systems/devices and may span distributed locations. Furthermore, each block shown may represent one or more such blocks as appropriate to a specific embodiment or may be combined with other blocks. Also, the calendar management system 310 may be implemented in software, hardware, firmware, or in some combination to achieve the capabilities described herein.

In the embodiment shown, computing system 300 comprises a computer memory (“memory”) 301, a display 302, one or more Central Processing Units (“CPU”) 303, Input/Output devices 304 (e.g., keyboard, mouse, CRT or LCD display, and the like), other computer-readable media 305, and network connections 306. The calendar management system 310 is shown residing in memory 301. In other embodiments, some portion of the contents, some or all of the components of the calendar management system 310 may be stored on and/or transmitted over the other computer-readable media 305. The components of the calendar management system 310 preferably execute on one or more CPUs 303 and extract and provide quotations, as described herein. Other code or programs 330 (e.g., an administrative interface, a Web server, and the like) and potentially other data repositories, such as data repository 340, also reside in the memory 301, and preferably execute on one or more CPUs 303. Of note, one or more of the components in FIG. 3 may not be present in any specific implementation. For example, some embodiments may not provide other computer readable media 305 or a display 302.

In a typical embodiment, as described above, the calendar management system 310 includes a calendar and event relationship manager 312, a calendar and event management API 320, an optional user interface 322, a calendar relationships data store 324, and a calendar cache 326. The calendar and event relationship manger 312 includes a calendar refresh system 314, a calendar update system 316, and a calendar synchronization system 318. The calendar management system 310 performs functions such as those described with reference to the calendar management system 114 of FIG. 1.

The calendar management system 310 interacts via the network 350 with calendar data sources 356, third-party content providers 354 and/or client devices 352. The network 350 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The client devices 352 include desktop computing systems, notebook computers, mobile phones, smart phones, personal digital assistants, and/or the like.

In an example embodiment, components/modules of the calendar management system 310 are implemented using standard programming techniques. For example, the calendar management system 310 may be implemented as a “native” executable running on the CPU 303, along with one or more static or dynamic libraries. In other embodiments, the calendar management system 310 may be implemented as instructions processed by a virtual machine that executes as one of the other programs 303. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the Calendar management system 310, such as in the calendar and event management API 320, can be made available by standard mechanisms such as through C, C++, C#, and Java APIs; libraries for accessing files, databases, or other data repositories; through scripting languages such as XML; or through Web servers, FTP servers, or other types of servers providing access to stored data. The calendar relationships data store 324 and calendar cache 326 may be implemented as one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the calendar management system 310 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

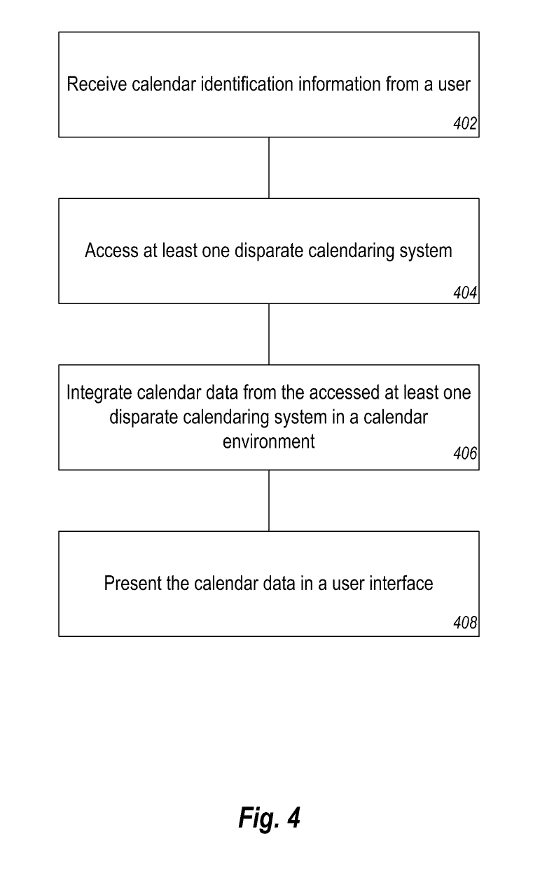

FIG. 4 is an example overview flow diagram of an example calendar management system. FIG. 4 illustrates an overview of the operation of an example calendar management system such as calendar management system 114 shown with reference to FIG. 1. At block 402, calendar identification information is received from the user. Such information may include but is not limited to, authentication information for access to a calendar, calendar location information and/or the like. At block 404, at least one disparate calendaring system is accessed. At block 406, calendar data from the accessed at least one disparate calendaring system is integrated in a calendaring environment. As each event and/or time based data entry is received from each of the calendaring systems, such information is integrated into a user interface in the calendaring environment for presentation to a user at block 408. After block 408, the process loops back to block 402 or any other block shown.

Alternatively and/or additionally an example calendar management system is configured to receive a calendar event request to modify the presented calendar data. The calendar event request may take the form of a meeting request, an email, a text entry and/or the like. The request is preferably received through the user interface, but may be received through another medium such as an email, text message, and/or the like. The request, using the calendar management system of FIG. 1, causes at least one disparate calendaring system to be altered based on the received calendar event request.

Alternatively and/or additionally an example calendar management system is configured to identify calendar data in a text based source, wherein the text based source is at least one of an email, text message, document, transcript, a webpage and/or the like. For example an email may include a date, a time, an indication of time (e.g. tomorrow, tonight, etc.). The system may add a hyperlink to the example email that when selected would cause a calendaring event request, such as a dialog in FIG. 2, that would add the selected event to a calendar.

Alternatively and/or additionally an example calendar management system may receive a request to modify calendar data. The request may include a first identifier that identifies a calendar of the at least one disparate calendaring systems. Once identified, the system may then access the identified calendar.

Although the techniques of the calendar management system are generally applicable to any type of time based data, the concepts and techniques described are applicable to other personal productivity data (e.g. contacts, to do lists, and/or the like) spread across multiple disparate systems. Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a calendar management system to be used for near real time collection of calendar data. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code flow, different code flows, etc. Thus, the scope of the techniques and/or functions described are not limited by the particular order, selection, or decomposition of steps described with reference to any particular routine.

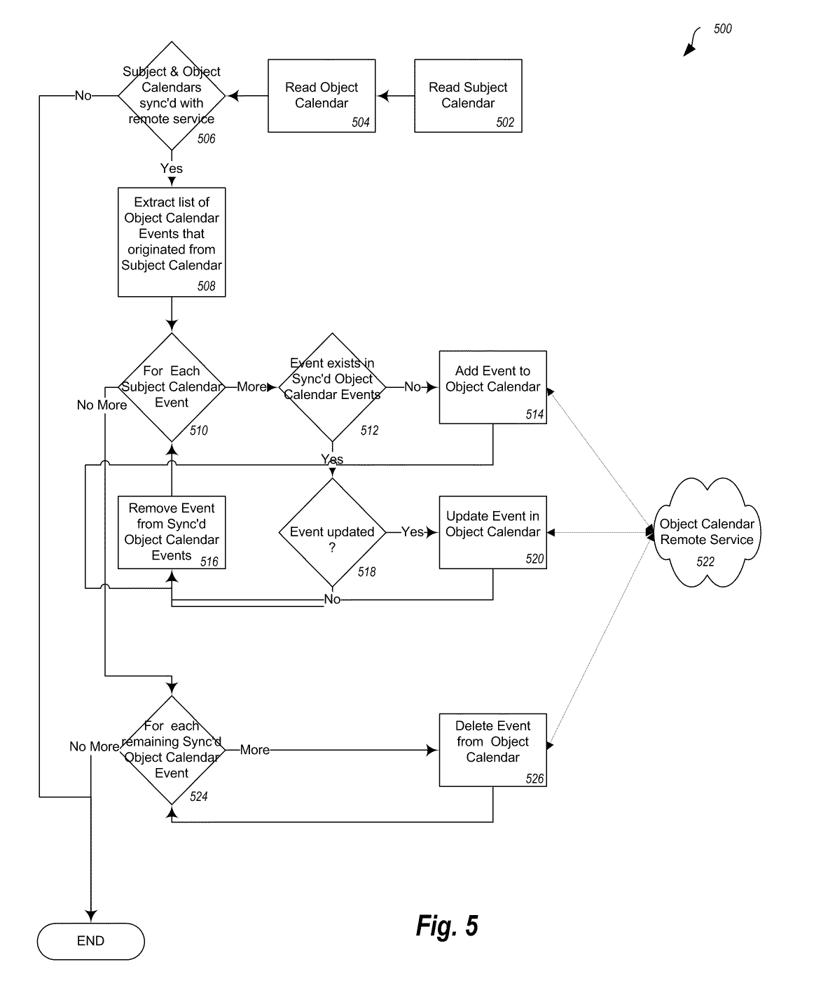

FIG. 5 is an example flow diagram of example synchronization provided by an example embodiment of calendar management environment. FIG. 5 illustrates an overview of a one direction synchronization operation of an example calendar synchronization system such as calendar synchronization system 128 shown with reference to FIG. 1. One way synchronization allows a user to have all of the events on a calendar of interest to be replicated to a calendar in a native calendar service (i.e. Exchange). For example a child's school calendar synchronized with a calendar within an exchange account so that information is easily accessible throughout the workday. At block 502, a subject calendar is read. At block 504 an object calendar is read. At decision block 506 subject and object calendars are synchronized with remote service. If not, then the process ends and will be retried once the calendars are refreshed from the remote service. If the calendars are synchronized then at block 508, a list of object calendar events are extracted that originated from the subject calendar. At looping block 510, each of the subject calendar events is processed. If there are more events to be synched, then it is determined, at block 512, if the event exists in a synchronized object of a calendar event. If so the event is updated at decision block 518. If not the event is added to the object calendar at block 514, which interacts with an object calendar remote service 522. If the event is updated at decision block 518, then event is updated in the object calendar at block 520, which interacts with an object calendar remote service 522. If the event is not updated at decision block 518, then at block 516 the event is removed from the synchronized object calendar events. If there are not any additional subject calendar events at block 510, then for each remaining synchronized object calendar event 524 that remains, the event is deleted from the object calendar at block 526, which interacts with an object calendar remote service 522. When there are not any additional remaining synchronized object calendar events at block 524, then the process ends.

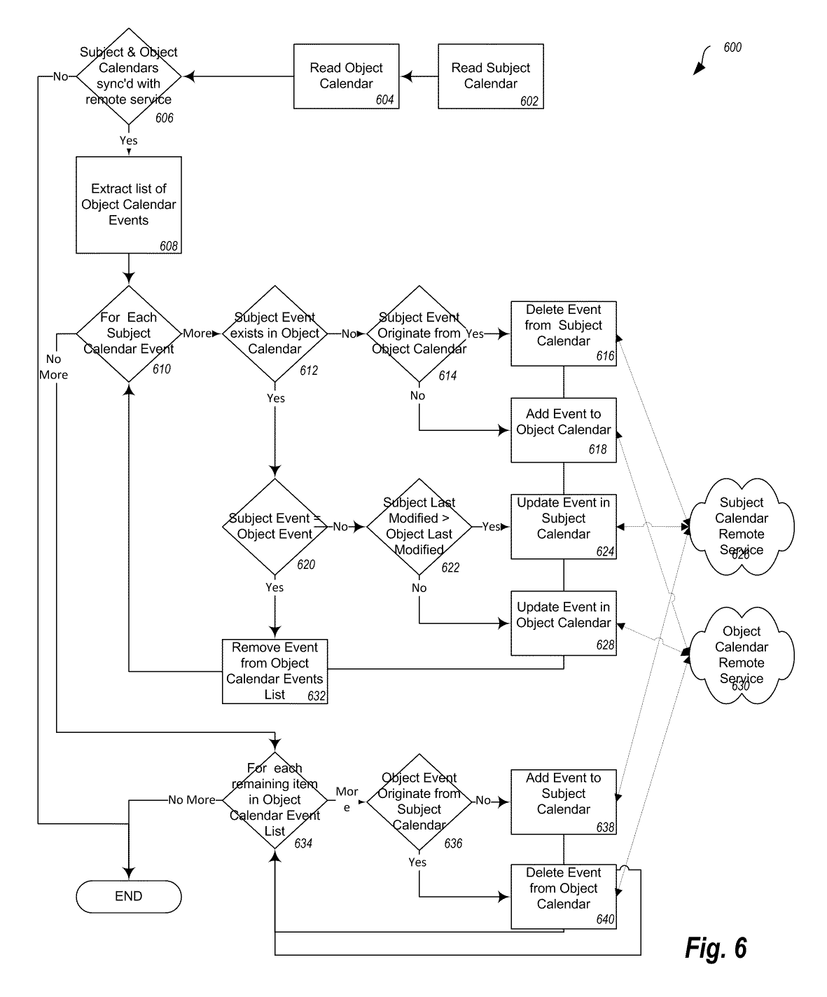

FIG. 6 is an example flow diagram of example synchronization provided by an example embodiment of calendar management environment. FIG. 6 illustrates an overview of a bidirectional synchronization operation of an example calendar synchronization system such as calendar synchronization system 128 shown with reference to FIG. 1. Bidirectional synchronization allows for keeping multiple calendars completely in sync. For example by establishing a “peer” between a Google and an Exchange calendar, any events added, updated, or deleted on one calendar will be reflected in the other and vice-versa. At block 602, a subject calendar is read. At block 604 an object calendar is read. At decision block 606 subject and object calendars are synchronized with a remote service. If not, then the process ends and will be retried once the calendars are refreshed from the remote service. If the calendars are synchronized then at block 608, a list of object calendar events are extracted that originated from the subject calendar. At looping block 610, each of the subject calendar events is processed. At decision block 612, it is determined whether the subject event exists in the object calendar, if not then it is determined if the subject event originated from the objected calendar at block 614. If so, then at block 616, the event is deleted from the subject calendar, in conjunction with the subject calendar remote service 626 and the object calendar remote service 630. If the subject event did not originate from then object calendar as determined in block 614, the event is added to the object calendar in block 618, in conjunction with the subject calendar remote service 626 and the object calendar remote service 630. If the subject event exists in the object calendar then it is determined if the subject event equals the object event in block 632. If so, then at block 632 the event is removed from the object calendar events list. If not, then at block 622 it is determined if the subject last modified is greater than the object last modified. If so the event is updated in the subject calendar at block 624 in conjunction with the subject calendar remote service 626 and the object calendar remote service 630. If not then the event is updated in the object calendar at block 628 in conjunction with the subject calendar remote service 626 and the object calendar remote service 630. When there are not any additional subject calendar events to be processed in block 610, then for each remaining item in the object calendar event list at block 634, it is determined if the object event originated from the subject calendar at block 636. If so, then the event is added to the subject calendar at block 638 and if not then the event is deleted from the object calendar at block 640, both in conjunction with the subject calendar remote service 626 and the object calendar remote service 630. When there are not any additional remaining items in the object calendar event list in block 634, then the process ends.

While the preferred embodiment of the invention has been illustrated and described, as noted above, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method in a computing system, comprising:
receiving calendar identification information from a user;
accessing at least one disparate calendaring system, wherein the at least one disparate calendaring system is related to the received calendar identification information; and
integrating calendar data from the accessed at least one disparate calendaring system in a calendar environment user interface.

2. The method of claim 1, further comprising:
providing the calendar environment user interface where calendar data from one or more disparate calendaring systems is provided to a user by:
presenting the calendar data in the user interface;
receiving a calendar event request to modify the presented calendar data; and
causing at least one disparate calendaring system to be altered based on the received calendar event request.

3. The method of claim 1 wherein receiving a request to modify the presented calendar data further comprises:
identifying calendar data in a text based source, wherein the text based source is at least one of an email, text message, document, transcript and a webpage; and
generating one or more calendar event requests based on the identified calendar data.

4. The method of claim 3 wherein the identified calendar related event data in the text based source is presented as a selectable hyperlink.

5. The method of claim 1 further comprising:
establishing a relationship between a first calendar and a second calendar; and
synchronizing a calendar event request in the first calendar with the second calendar based on the established relationship between the first calendar and the second calendar.

6. The method of claim 5 wherein synchronizing a calendar event request further comprises synchronizing a calendar event request in the second calendar with the first calendar.

7. The method of claim 1 wherein receiving a request to modify the presented calendar data further comprises:
receiving a first identifier in the received request to modify that identifies a calendar in the at least one disparate calendaring systems;
accessing the identified calendar based on the received first identifier; and
causing the request to modify to be stored in the accessed calendar based on the received first identifier.

8. The method of claim 1 further comprising:
providing the calendar environment user interface by:
presenting calendar related events from the at least one disparate calendaring systems; and
enabling a calendar event to be moved from a first calendar to a second calendar by:
dragging a graphical representation of the calendar event from a screen area related the first calendar to a screen area related to the second calendar.

9. The method of claim 6 further comprising providing a drop box in the user interface, wherein the drop box is configured to receive calendar related events.

10. The method of claim 1 further comprising:
monitoring the at least one disparate calendaring systems for any changes to calendar related events;
storing a monitored changes in a calendar cache; and
presenting the stored calendar cache to a user.

11. The method of claim 1 wherein the at least one disparate calendaring system is at least one of a digital calendar, a calendar service, and at least one digital calendar within a calendar service.

12. The method of claim 1 further comprising posting at least one calendar related event to a social networking site.

13. The method of claim 1 further comprising:
providing a calendar subscription marketplace, wherein the calendar subscription marketplace is configured to publish at least one of time based products and time based promotions; and
receiving a request to add at least one of the time based products and time based promotions to at least one disparate calendaring system.

14. The method of claim 1 further comprises providing a subscription catalog of public calendars categorized by at least one of location and topic.

15. The method of claim 1 further comprising:
maintaining a relationship between at least one calendar events on the at least one disparate calendaring systems, wherein changes to an event on one disparate calendaring system are automatically reflected on all other disparate calendaring system.

16. The method of claim 15 wherein a relationship exists between at least one of an event and a calendar.

17. The method of claim 1 further comprises providing an enterprise communication channel for delivering time based information to at least one user.

18. The method of claim 2 wherein calendar data is presented in the calendar environment with each calendar of the at least one disparate calendaring system is presented in each row of the user interface.

19. A computing system configured to facilitate a calendaring environment, comprising
a non-transitory memory medium; and
a module stored on the non-transitory memory medium that is configured, when executed to:
provide a calendaring environment where calendar data from at least one disparate calendaring system is combined and displayed in a user interface by:
receiving calendar identification information from a user, wherein the calendar identification information provides access to a users calendar;
accessing at least one disparate calendaring system, wherein the at least one disparate calendaring system is related to the received calendar identification information; and
integrating calendar data from the accessed at least one disparate calendaring system in a calendar environment.

20. A computer readable memory medium whose contents, when executed, cause a computing system to facilitate a calendar environment, by:
providing a calendaring environment where calendar data from at least one disparate calendaring system is combined and displayed in a user interface by:
receiving calendar identification information from a user, wherein the calendar identification information provides access to a users calendar;
accessing at least one disparate calendaring system, wherein the at least one disparate calendaring system is related to the received calendar identification information; and
integrating calendar data from the accessed at least one disparate calendaring system in a calendar environment.
